(19) United States
(12) Patent Application Publication
(10) Pub. No.: US 2018/0337005 A1
(43) Pub. Date: Nov. 22, 2018

(54) KEYBOARD

(71) Applicant: Primax Electronics Ltd., Taipei City (TW)

(72) Inventors: Chuang-Shu JHUANG, Taipei (TW); Sheng-Huang HUANG, Taipei (TW)

(21) Appl. No.: 15/815,246

(22) Filed: Nov. 16, 2017

(30) Foreign Application Priority Data
May 19, 2017 (CN) 201710357775.8

(51) Int. Cl. H01H 3/12; H01H 13/705; H01H 13/70

(52) U.S. Cl. CPC H01H 3/125; H01H 13/705; H01H 2003/127; H01H 2229/022; H01H 13/7013

(57) ABSTRACT

The present invention relates to a keyboard, including a baseboard, connecting elements, and replaceable keys. The replaceable key includes a connecting plate and a key cap. The connecting plate has a first fixing portion, and the key cap has a second fixing portion. The connecting element is separately connected to the baseboard and the connecting plate, and the key cap and the connecting plate may be combined by means of the first fixing portion and the second fixing portion. Therefore, the user does not contact a connecting element when disassembling a key cap, so that the connecting element is not damaged and the key cap is easy to disassemble and assemble.

### FIELD OF THE INVENTION

The present invention relates to an input device, and in particular, to a keyboard having a plurality of key structures.

### BACKGROUND OF THE INVENTION

Common peripheral input device of a computer include a mouse, a keyboard device, a trackball device, and the like. The keyboard can be used by users to directly input words and symbols to the computer and is therefore draw attention from users and input device manufacturers. A keyboard having a plurality of key structures is pretty common.

Subsequently, the architecture of the key structure of the keyboard is described. A key structure including a scissor-type connecting element is used as an example. Referring to FIG. 1, FIG. 1 is a schematic cross sectional side view of a conventional key structure. A conventional key structure 1 includes key caps 11, a scissor-type connecting element 12, elastic elements 13, a membrane switch circuit 14, and a baseboard 15. The baseboard 15 is configured to support the key caps 11, the scissor-type connecting element 12, the elastic elements 13, and the membrane switch circuit 14. The scissor-type connecting element 12 is configured to connect the baseboard 15 and the key caps 11.

The scissor-type connecting element 12 is positioned between the baseboard 15 and the key caps 11 and separately connects the baseboard 15 and the key caps 11. The scissor-type connecting element 12 includes a first frame 121 and a second frame 122. A first end of the first frame 121 is connected to the key caps 11, and a second end of the first frame 121 is connected to the baseboard 15. The elastic elements 13 are surrounded by the scissor-type connecting element 12, and the membrane switch circuit 14 has a plurality of key connecting points (not shown). The key connecting point outputs a corresponding key signal when being triggered. The elastic elements 13 are disposed on the membrane switch circuit 14 and one elastic element 13 corresponds to one key connecting point. When an elastic element 13 is pressed, the elastic element 13 deforms and presses a corresponding key connecting point of the membrane switch circuit 14, to generate a key signal.

The operation of the key structure 1 when being pressed by a user is described below. In FIG. 1, when a user presses the key cap 11, the key cap 11 is under a stress and pushes the scissor-type connecting element 12, so that the scissor-type connecting element 12 moves. Therefore, the key cap 11 may move downwards relative to the baseboard 15 and presses a corresponding elastic element 13. At this time, the elastic element 13 deforms and presses the membrane switch circuit 14, to trigger a key connecting point of the membrane switch circuit 14, so that the membrane switch circuit 14 outputs a corresponding key signal. When the user stops pressing the key cap 11, the key cap 11 is no longer under a stress and stops pressing the elastic element 13, so that the elastic element 13 recovers to the original state due to its elasticity and meanwhile provides an upward elastic restoring force, and the key cap 11 is therefore pushed back to the position before being pressed. The foregoing is a conventional key structure and the operation thereof.

With the development of technologies, the functionality and lightening and thinning of a keyboard are increasingly improved, and therefore requirements for a keyboard by users are correspondingly increased. For example, some users need to change the style or the material of key caps according to personal preferences. Generally, a keyboard uses key caps made of plastic. The user may want to replace some key caps with key caps made of wood (or other materials). However, for common users, it is not easy to disassemble a key cap 11 of a conventional key structure 1, and damage may be caused to the scissor-type connecting element 12 or other elements when the user disassembles the key cap 11.

Therefore, a keyboard having a key cap that is easy to change is needed.

### SUMMARY OF THE INVENTION

The present invention is directed to provide a keyboard having a key cap that is easy to change.

In a preferable embodiment, the present invention provides a keyboard, including a baseboard, a connecting element, and a replaceable key. The connecting element is positioned on the baseboard and connected to the baseboard. The replaceable key is connected to the connecting element and capable of moving relative to the baseboard. The replaceable key includes a connecting plate and a key cap. The connecting plate is positioned above the connecting element and connected to the connecting element, the connecting plate having a first fixing portion. The key cap is exposed out of the keyboard and covers the connecting plate, the key cap having a second fixing portion, where the first fixing portion is capable of being combined with the second fixing portion, so as to secure the key cap onto the connecting plate.

In a preferable embodiment, the second fixing portion passes through the first fixing portion and then is capable of expanding outwards to catch with the first fixing portion, so as to secure the key cap onto the connecting plate.

In a preferable embodiment, the first fixing portion passes through the second fixing portion and then is capable of expanding outwards to catch with the second fixing portion, so as to secure the key cap onto the connecting plate.

In brief, in the keyboard of the present invention, the connecting element is separately connected to the baseboard and the connecting plate, and then the key cap and the connecting plate are combined by means of the first fixing portion and the second fixing portion. The connecting elements are connected to the connecting plate, rather than be connected to the key caps as in the conventional technologies. Therefore, the user does not contact a connecting element when disassembling a key cap, so that the connecting element is not damaged and the key cap is easy to disassemble and assemble, so as to resolve the problem of the conventional technologies.

### BRIEF DESCRIPTION OF THE DRAWINGS

FIG. 1 is a schematic cross sectional side view of a conventional key structure;

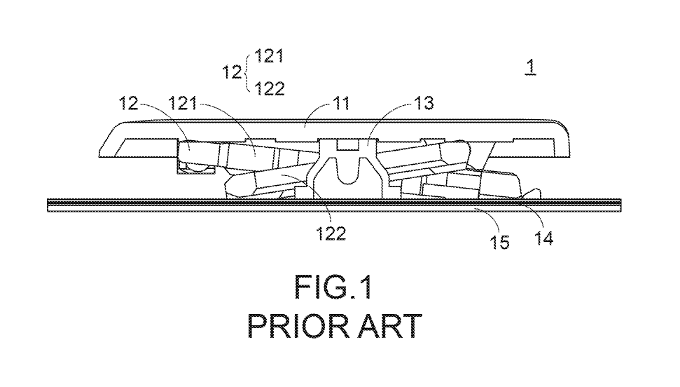

FIG. 2 is a schematic structural diagram of the appearance of a keyboard in a first preferable embodiment of the present invention;

FIG. 3 is a schematic exploded view of a partial structure of the keyboard in the first preferable embodiment of the present invention;

FIG. 4 is a schematic exploded view in another perspective of a replaceable key of the keyboard in the first preferable embodiment of the present invention;

FIG. 5 is a schematic cross sectional side view of a partial structure of the keyboard in the first preferable embodiment of the present invention;

FIG. 6 is a schematic structural view of the appearance of the keyboard after a key cap is changed in the first preferable embodiment of the present invention;

FIG. 7 is a schematic exploded view of a partial structure of a keyboard in a second preferable embodiment of the present invention; and

FIG. 8 is a schematic exploded view in another perspective of a replaceable key of the keyboard in the second preferable embodiment of the present invention.

### DETAILED DESCRIPTION OF THE PREFERRED EMBODIMENT

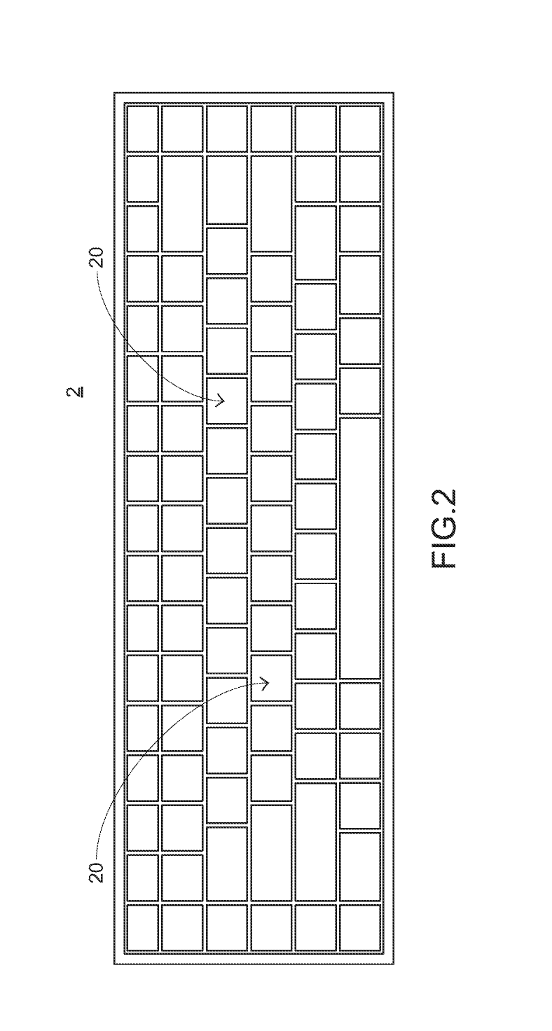

In view of the problem of the conventional technologies, the present invention provides a keyboard capable of resolving the problem of the conventional technologies. First, the structure of a keyboard of the present invention is described. Referring to FIG. 2, FIG. 2 is a schematic structural diagram of the appearance of a keyboard in a first preferable embodiment of the present invention. A keyboard 2 of the present invention includes a plurality of replaceable keys 20 which is exposed out of the keyboard 2. The replaceable keys 20 are to be pressed by a user with fingers, to generate corresponding signals, and the signals are transmitted to a computer (not shown) connected to the keyboard 2, so that the computer executes functions of the pressed keys. The replaceable keys 20 may be replaced with needed keys according to preferences of a user.

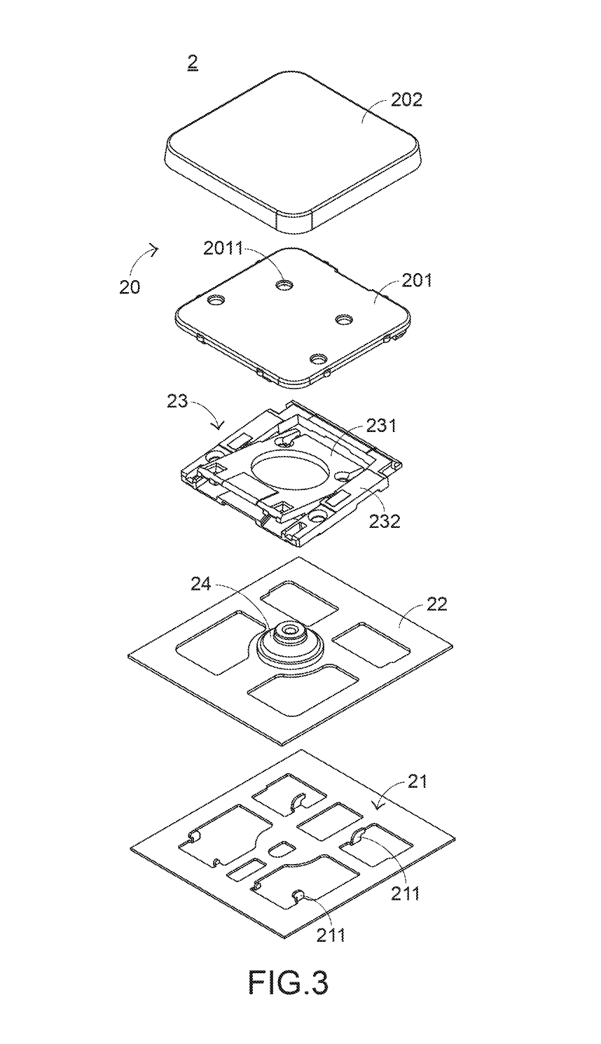

Subsequently, the internal structure of the keyboard 2 of the present invention is described. Referring to FIG. 3, FIG. 3 is a schematic exploded view of a partial structure of the keyboard in the first preferable embodiment of the present invention. In addition to the plurality of replaceable keys 20, the keyboard 2 further includes a baseboard 21, a switch circuit board 22, a plurality of connecting elements 23 (only one connecting element is shown), and a plurality of elastic elements 24 (only one elastic element is shown). The baseboard 21 is disposed below the plurality of replaceable keys 20 and is connected to the plurality of connecting elements 23. The plurality of connecting elements 23 is positioned on the baseboard 21 and is separately connected to the baseboard 21 and the corresponding replaceable keys 20. Since the replaceable keys 20 are connected to the corresponding connecting elements 23, the replaceable keys 20, when being pressed, are capable of moving relative to the baseboard 21. The switch circuit board 22 is positioned between the plurality of replaceable keys 20 and the baseboard 21, and the elastic element 24 is positioned between the corresponding replaceable key 20 and the switch circuit board 22. When the replaceable key 20 is pressed by a user and moves, the elastic element 24 is pressed by the replaceable key 20 to press the switch circuit board 22, so that the switch circuit board 22 outputs a corresponding key signal. In this preferable embodiment, the switch circuit board 22 is a membrane switch circuit, and the elastic element 24 is a rubbery elastomer. The internal structure of the switch circuit board 22 consists of an upper circuit board, a lower circuit board, and an insulation layer, which is well known by any person skilled in the art, and therefore is not described in detail herein.

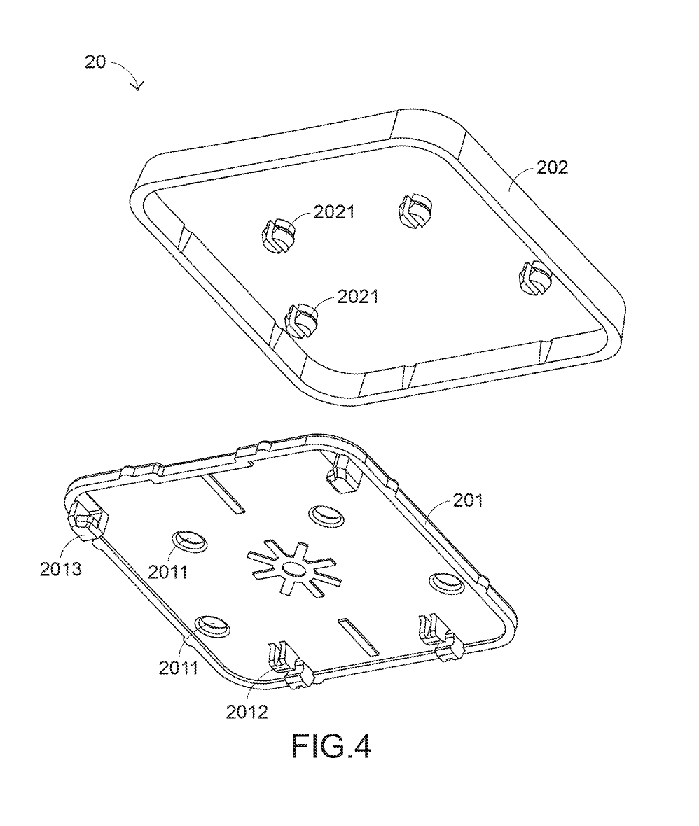

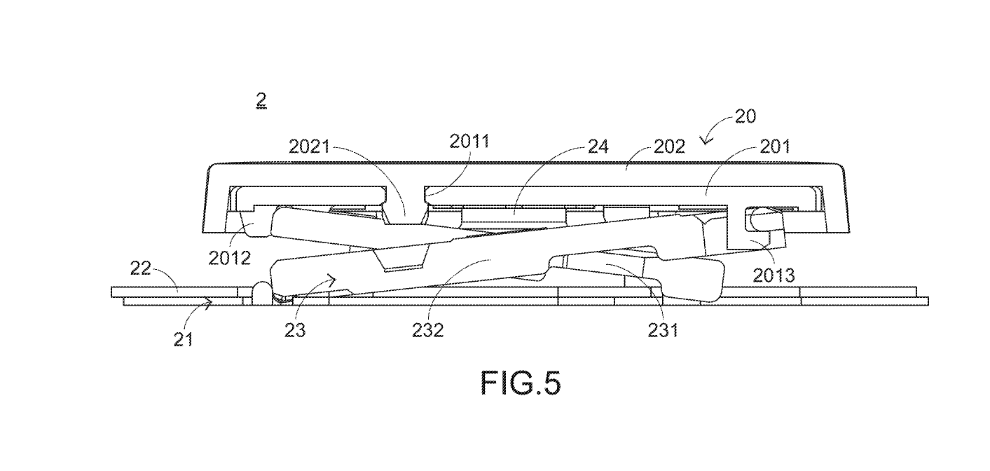

Referring to FIG. 3, FIG. 4, and FIG. 5, FIG. 4 is a schematic exploded view in another perspective of a replaceable key of the keyboard in the first preferable embodiment of the present invention, and FIG. 5 is a schematic cross sectional side view of a partial structure of the keyboard in the first preferable embodiment of the present invention. FIG. 4 shows the structure of a replaceable key 20. The replaceable key 20 includes a connecting plate 201 and a key cap 202 exposed out of the keyboard 2. The connecting plate 201 is positioned above a corresponding connecting element 23 and connected to the connecting element 23. The connecting plate 201 includes a plurality of first fixing portions 2011, a plurality of fixed hooks 2012, and a plurality of movable hooks 2013. The plurality of first fixing portions 2011 pass through the connecting plate 201. The plurality of fixed hooks 2012 is disposed on a lower surface of the connecting plate 201 and positioned at a first side of the connecting plate 201, and the plurality of movable hooks 2013 is disposed on the lower surface of the connecting plate 201 and positioned at a second side of the connecting plate 201. The key cap 202 is exposed out of the keyboard 2 and covers the connecting plate 201. The key cap 202 has a plurality of second fixing portions 2021 and each second fixing portion 2021 corresponds to one first fixing portion 2011. The key cap 202 is secured onto the connecting plate 201 by combining the first fixing portions 2011 and the second fixing portions 2021.

The plurality of second fixing portions 2021 respectively passes through the corresponding first fixing portions 2011 and then expands outwards to respectively catch with the corresponding first fixing portions 2011, so as to secure the key cap 202 onto the connecting plate 201. In this preferable embodiment, the first fixing portion 2011 is a circular hole, and the second fixing portion 2021 is a corresponding circular shaft knot. The circular shaft knot uses a two separate piece structure, so that the circular shaft knot has a shrunk volume when passing through the circular hole, and expands outwards after passing through the circular hole, so as to catch with the circular hole. This embodiment is used as an example only, and the present invention is not limited thereto. In another preferable embodiment, the following design may also be used: the second fixing portion of the key cap is a circular hole, and the first fixing portion of the connecting plate is a corresponding circular shaft knot.

In FIG. 3, FIG. 4, and FIG. 5, the baseboard 21 includes a plurality of baseboard hooks 211. The plurality of baseboard hooks 211 is disposed on an upper surface of the baseboard 21 and has a function of being combined with the connecting elements 23. In another aspect, the connecting element 23 includes a first frame 231 and a second frame 232. A first end of the first frame 231 is connected to the plurality of fixed hooks 2012 of the connecting plate 201, and a second end of the first frame 231 is connected to the baseboard hooks 211 of the baseboard 21. The second frame 232 is combined with the first frame 231 and is capable of swinging relative to the first frame 231. A first end of the second frame 232 is connected to the baseboard hooks 211 of the baseboard 21, and a second end of the second frame 232 is connected to the plurality of movable hooks 2013 of the connecting plate 201. Moreover, the second end of the second frame 232 may slide in the movable hooks 2013. In this way, the connecting element 23 may be separately connected to the baseboard 21 and the connecting plate 201, so that the second frame 232 is capable of swinging relative to the first frame 231, and driving the connecting plate 201 to move up and down relative to the baseboard 21. In this preferable embodiment, the connecting element 23 is a scissor-type connecting element.

The operation of the replaceable keys 20 when being pressed is described below. When a user presses a key cap 202 of a replaceable key 20, the key cap 202 and the connecting plate 201 moves downwards relative to the baseboard 21, so that the connecting element 23 is pressed to swing. Moreover, the connecting plate 201 that moves downwards pushes elastic element 24, so that the elastic element 24 is pressed to deform and trigger the switch circuit board 22, so as to generate a corresponding key signal. When the user no longer presses the replaceable key 20, the key cap 202 and the connecting plate 201 may move upwards relative to the baseboard 21 due to an elastic force generated recovery of the elastic element 24 from the deformed state, so as to push the connecting plate 201 to move upwards, and meanwhile driving the connecting element 23 to swing and recover from a stacked state to an open state, and the key cap 202 may recover to the position before being pressed.

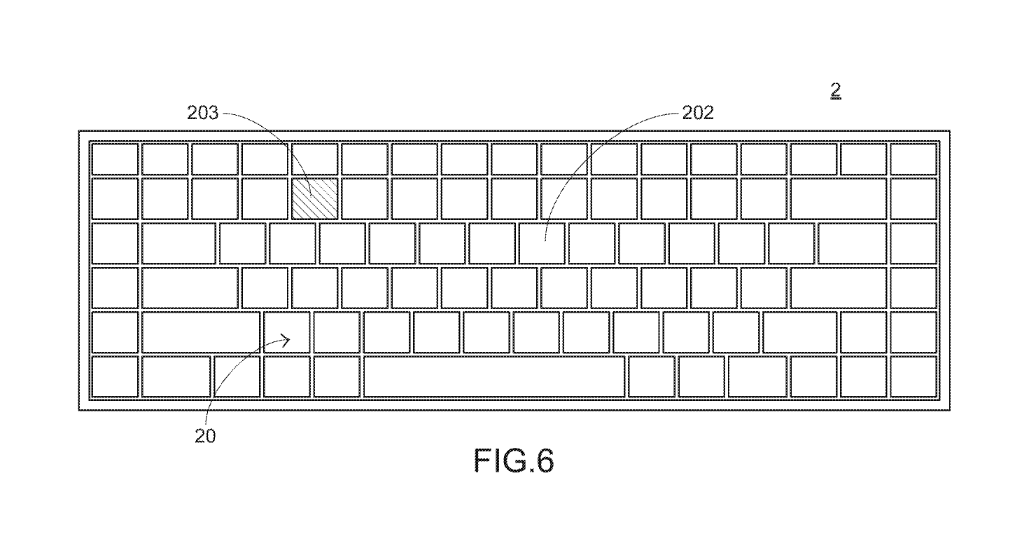

By means of the structure of the first fixing portion 2011 and the second fixing portion 2021, the key cap 202 may be easily combined with the connecting plate 201, as well as being easily separated from the connecting plate 201. When a user wants to replace a key cap 202 made of plastic in the keyboard 2 with another key cap 203 made of other materials (for example, glass, or wood), the key cap 202 may be disassembled from the connecting plate 201 by separating the first fixing portion 2011 and the second fixing portion 2021. After then, the another key cap 203 is combined with the connecting plate 201. The keyboard 2 after the change is shown in FIG. 6.

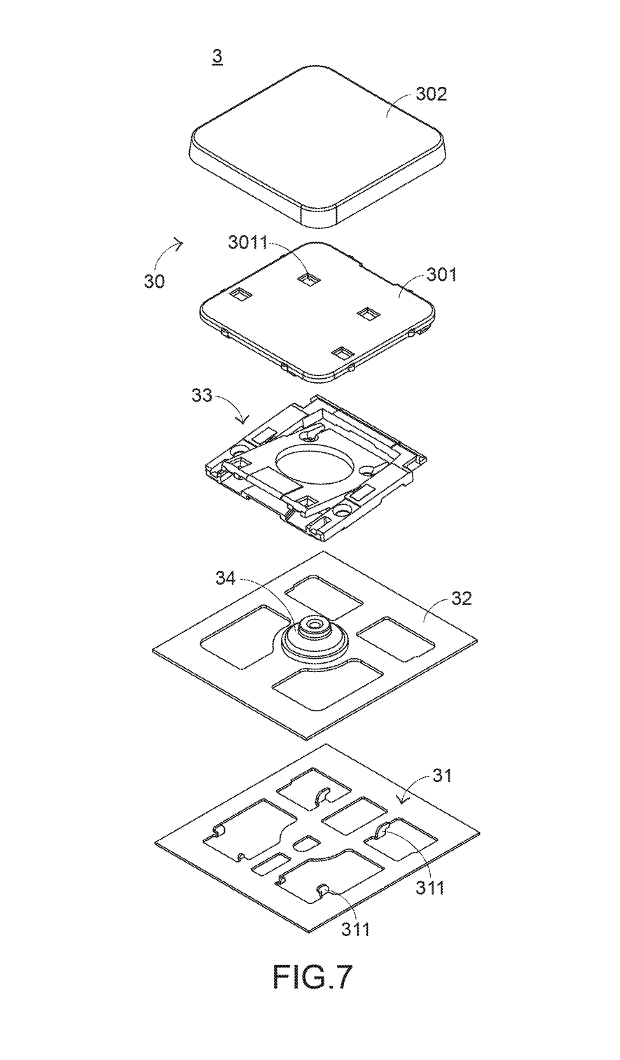

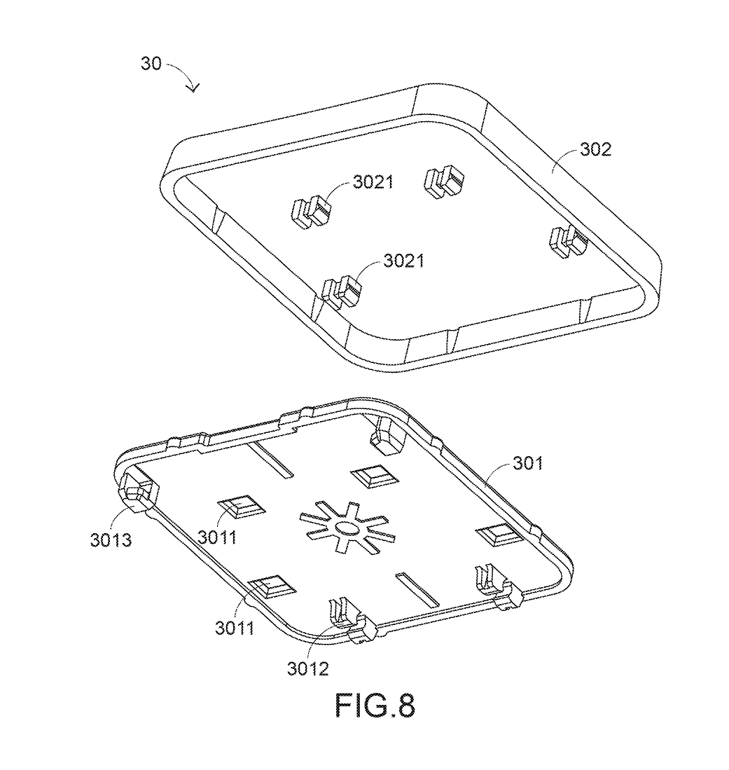

In addition, the present invention further provides a second preferable embodiment which is different from the foregoing method. Referring to both FIG. 7 and FIG. 8, FIG. 7 is a schematic exploded view of a partial structure of a keyboard in a second preferable embodiment of the present invention, and FIG. 8 is a schematic exploded view in another perspective of a replaceable key of the keyboard in the second preferable embodiment of the present invention. A keyboard 3 includes a plurality of replaceable keys 30 (only one replaceable key is shown), a baseboard 31, a switch circuit board 32, a plurality of connecting elements 33 (only one connecting element is shown), and a plurality of elastic elements 34. The baseboard 31 includes a plurality of baseboard hooks 311, and the replaceable key 30 includes a connecting plate 301 and a key cap 302. The connecting plate 301 includes a plurality of first fixing portions 3011, a plurality of fixed hooks 3012 and a plurality of movable hooks 3013. Moreover, the key cap 302 has a plurality of second fixing portions 3021. The structures and functions of elements in the keyboard 3 of this preferable embodiment are substantially the same as those of the foregoing first preferable embodiment, and are not described in detail herein. The difference between the first and second preferable embodiments lies in the shape of the first fixing portion 3011 and the second fixing portion 3021.

In this preferable embodiment, the first fixing portion 3011 is a rectangular hole, and the second fixing portion 3021 is a corresponding rectangular shaft knot. This embodiment is used as an example only, and the present invention is not limited thereto. In another preferable embodiment, the following design may also be used: the second fixing portion of the key cap is a rectangular hole, and the first fixing portion of the connecting plate is a corresponding rectangular shaft knot. The operations of combination and separation between the rectangular shaft knot and the rectangular hole are the same as those of the circular shaft knot and the circular hole, and are therefore not described in detail herein.

Based on the above, in the keyboard of the present invention, the connecting element is separately connected to the baseboard and the connecting plate, and then the key cap and the connecting plate are combined by means of the first fixing portion and the second fixing portion. The connecting elements are connected to the connecting plate, rather than be connected to the key caps as in the conventional technologies. Therefore, the user does not contact a connecting element when disassembling a key cap, so that the connecting element is not damaged and the key cap is easy to disassemble and assemble, so as to resolve the problem of the conventional technologies.

The above are only the preferable embodiments of the present invention, and the present invention needs not be limited to the disclosed embodiments. Therefore, all equivalent changes or modifications included within the spirit and scope of the present invention fall within the scope of the claims of the present invention.

What is claimed is:

1. A keyboard, comprising:
a baseboard;
a connecting element, positioned on the baseboard and connected to the baseboard; and
a replaceable key, connected to the connecting element and capable of moving relative to the baseboard, wherein the replaceable key comprises:
a connecting plate, positioned above the connecting element and connected to the connecting element, the connecting plate having a first fixing portion; and
a key cap, exposed out of the keyboard and covering the connecting plate, the key cap having a second fixing portion, wherein the first fixing portion is capable of being combined with the second fixing portion, so as to secure the key cap onto the connecting plate.

2. The keyboard according to claim 1, wherein the second fixing portion passes through the first fixing portion and then is capable of expanding outwards to catch with the first fixing portion, so as to secure the key cap onto the connecting plate.

3. The keyboard according to claim 2, wherein the first fixing portion is a circular hole or a rectangular hole, and the second fixing portion is a corresponding circular shaft knot or rectangular shaft knot.

4. The keyboard according to claim 1, wherein the first fixing portion passes through the second fixing portion and then is capable of expanding outwards to catch with the second fixing portion, so as to secure the key cap onto the connecting plate.

5. The keyboard according to claim 4, wherein the second fixing portion is a circular hole or a rectangular hole, and the first fixing portion is a corresponding circular shaft knot or rectangular shaft knot.

6. The keyboard according to claim 1, wherein the connecting element comprises:
a first frame, a first end of the first frame being connected to the connecting plate, and a second end of the first frame being connected to the baseboard; and
a second frame, combined with the first frame and capable of swinging relative to the first frame, a first end of the second frame being connected to the baseboard and a second end of the second frame being connected to the connecting plate.

7. The keyboard according to claim 6, wherein the connecting plate further comprises:
a fixed hook, disposed on a lower surface of the connecting plate, positioned at a first side of the connecting plate, and configured to be connected to the first end of the first frame; and
a movable hook, disposed on the lower surface of the connecting plate, positioned at a second side of the connecting plate, and configured to being connected to the second end of the second frame, so that the second end of the second frame is enabled to slide in the movable hook.

8. The keyboard according to claim 6, wherein the baseboard comprises a plurality of baseboard hooks, disposed on an upper surface of the baseboard, and configured to be connected to the second end of the first frame, or be connected to the first end of the second frame.

9. The keyboard according to claim 1, further comprising:
a switch circuit board, positioned below the replaceable key, and configured to output a key signal due to movement of the replaceable key; and
an elastic element, positioned between the connecting plate and the switch circuit board, and configured to be pressed by the moved connecting plate, so as to press the switch circuit board, wherein when the elastic element is no longer pressed by the connecting plate, the elastic element provides an elastic force to the connecting plate.

10. The keyboard according to claim 1, further comprising another key cap, capable of being combined with the connecting plate after the above key cap and the connecting plate are separated.
